(19) United States
(12) Patent Application Publication
(10) Pub. No.: US 2018/0208330 A1
(43) Pub. Date: Jul. 26, 2018

(54) STRUCTURE REINFORCEMENT WITH POLYMER MATRIX COMPOSITE

(71) Applicant: Sikorsky Aircraft Corporation, Stratford, CT (US)

(72) Inventors: Wenping Zhao, Jr., Glastonbury, CT (US); Zaffir A. Chaudhry, Glastonbury, CT (US); Darryl Mark Toni, Clinton, CT (US); Peter Kummer, Milford, CT (US)

(21) Appl. No.: 15/745,474

(22) PCT Filed: Jul. 13, 2016
(86) PCT No.: PCT/US16/42031

§ 371 Date: Jan. 17, 2018

Related U.S. Application Data
(60) Provisional application No. 62/196,005, filed on Jul. 23, 2015.

(51) Int. Cl. B64F 5/40; B32B 7/12; B32B 15/08; B32B 27/20; B32B 37/12; B23P 6/00

(52) U.S. Cl. CPC B64F 5/40; B32B 7/12; B32B 15/08; B32B 27/20; B23P 2700/01; B23P 6/00; B32B 2037/1253; B32B 2305/076; B32B 37/12

(57) ABSTRACT

A structural reinforcement member is provided to be affixable to a metallic member. The metallic member defines a stress concentration section at which the metallic member is subject to loading in at least one direction such that stress is generated at the stress concentration section in at least one corresponding principal stress direction. The structural reinforcement member includes a polymer matrix composite (PMC) patch element and a bondline. The PMC patch element includes fibers suspended within a polymer matrix. The bondline is disposed to affix the PMC patch element to a surface of the metallic member at the stress concentration section such that the fibers extend along the principal stress direction.

### BACKGROUND OF THE DISCLOSURE

The subject matter disclosed herein relates to structural reinforcement and, more particularly to aircraft frame structural reinforcement with polymer matrix composite (PMC) patch.

Conventional aircraft frame structures are often made of metals, such as aluminum or other similar materials. Meanwhile, stress risers often occur in and around some joints or attachment areas of aircraft frame structures and these stress risers can tend to be challenging to manage due to design and manufacturing limitations. As a consequence, structural fatigue damage, such as cracks, over the aircraft life span could occur in the aircraft frame structures with repair and replacement processes being relatively costly.

Lately polymer matrix composite (PMC) structures are gaining increasing acceptance for use in aircraft frame structures due to their inherent high stiffness, low weight and superior fatigue performance characteristics.

### BRIEF DESCRIPTION OF THE DISCLOSURE

According to one aspect of the disclosure, a structural reinforcement member is provided to be affixable to a metallic member. The metallic member defines a stress concentration section at which the metallic member is subject to loading in at least one direction such that stress is generated at the stress concentration section in at least one corresponding principal stress direction. The structural reinforcement member includes a polymer matrix composite (PMC) patch element and a bondline. The PMC patch element includes fibers suspended within a polymer matrix. The bondline is disposed to affix the PMC patch element to a surface of the metallic member at the stress concentration section such that the fibers extend along the principal stress direction.

In accordance with additional or alternative embodiments, the metallic member is formed to define holes and the PMC patch element reinforces the metallic member against stress concentrations associated with the holes.

In accordance with additional or alternative embodiments, the PMC patch has a rectangular shape with rounded corners.

In accordance with additional or alternative embodiments, the PMC patch is tapered in a thickness dimension.

In accordance with additional or alternative embodiments, the bondline includes at least one of a flexible prepreg or thermoplastic tape.

In accordance with additional or alternative embodiments, the bondline includes adhesive that is co-curable with the PMC patch element.

In accordance with additional or alternative embodiments, the PMC patch element includes resin infused fabric.

In accordance with additional or alternative embodiments, the loading places the PMC patch in at least one or more of tension, compression and shear.

In accordance with additional or alternative embodiments, the metallic member is subject to loading in principal and secondary directions such that stress is generated at the stress concentration section in at least one corresponding principal stress direction and at least corresponding secondary stress direction, the PMC patch element including principal and secondary fibers suspended within the polymer matrix and the bondline being disposed to affix the PMC patch element to the surface of the metallic member at the stress concentration section such that the principal fibers extend along the principal stress direction and the secondary fiber extend along the secondary stress direction.

In accordance with additional or alternative embodiments, the PMC patch element and the bondline are in-situ cured on the metallic member.

According to yet another aspect of the disclosure, a structural reinforcement method is provided for use with a metallic member defining a stress concentration section at which the metallic member is subject to loading in at least one direction such that stress is generated at the stress concentration section in at least one corresponding principal stress direction. The method includes forming a polymer matrix composite (PMC) patch element comprising fibers suspended within a polymer matrix and affixing the PMC patch element to a surface of the metallic member at the stress concentration section such that the fibers extend along the principal stress direction with the PMC patch element thereby reinforcing the metallic member against the loading.

In accordance with additional or alternative embodiments, the forming includes tapering the PMC patch element in a thickness dimension.

In accordance with additional or alternative embodiments, the affixing includes aligning principal ones of the fibers to extend along the principal stress direction and aligning secondary ones of the fibers to extend along a secondary stress direction defined transversely relative to the principal stress direction.

In accordance with additional or alternative embodiments, the affixing includes co-curing the PMC patch element with adhesive.

In accordance with additional or alternative embodiments, the affixing includes in-situ curing of the PMC patch and adhesive on the metallic member.

These and other advantages and features will become more apparent from the following description taken in conjunction with the drawings.

### BRIEF DESCRIPTION OF THE DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a side view of a reinforcement member affixed to a frame structure in accordance with embodiments;

FIG. 2 is an axial view of the reinforcement member of FIG. 1;

FIG. 3 is a plan view of the reinforcement member of FIG. 1.

FIG. 4 is a schematic diagram illustrating an internal fiber structure of a reinforcement member in accordance with embodiments;

FIG. 5 is a plan view of the reinforcement member of FIGS. 1-3 in accordance with alternative embodiments;

FIG. 6 is a side view of a reinforcement member affixed to various parts of a curved frame structure in accordance with embodiments; and

FIG. 7 is a side view of a reinforcement member affixed to various parts of a frame structure in accordance with alternative embodiments.

The detailed description explains embodiments of the disclosure, together with advantages and features, by way of example with reference to the drawings.

### DETAILED DESCRIPTION OF THE DISCLOSURE

As will be described below, the use polymer matrix composites (PMC) to reinforce metallic aircraft frame structures at stress concentration areas in particular and to therefore mitigate fatigue issues is proposed. Such use would then be an alternative to replacing the complete metallic frame member.

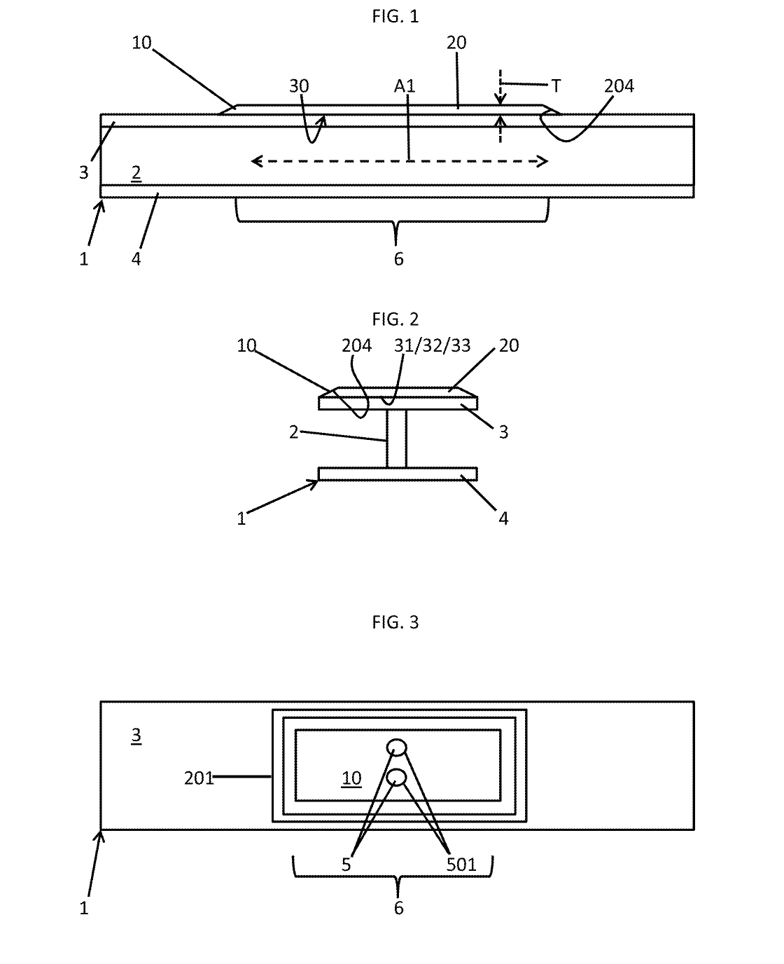

With reference to FIGS. 1-3, a frame structure 1 is provided and may be an aircraft frame structure. The frame structure 1 may be formed of metal, such as aluminum, metallic alloy or another similar material. The frame structure 1 may be configured as an I-beam and thus may include a central web 2 that extends along a longitudinal axis A1, a first flange 3 and a second flange 4. The first flange 3 is coupled to a first side of the central web 2 at a central section thereof and the second flange 4 is coupled to a second side of the central web 2 at a central section thereof. The first and second flanges 3 and 4 both extend along the longitudinal axis A2. The frame structure 1 is also formed to define holes 5 or other structural discontinuities at a predefined axial location thereof.

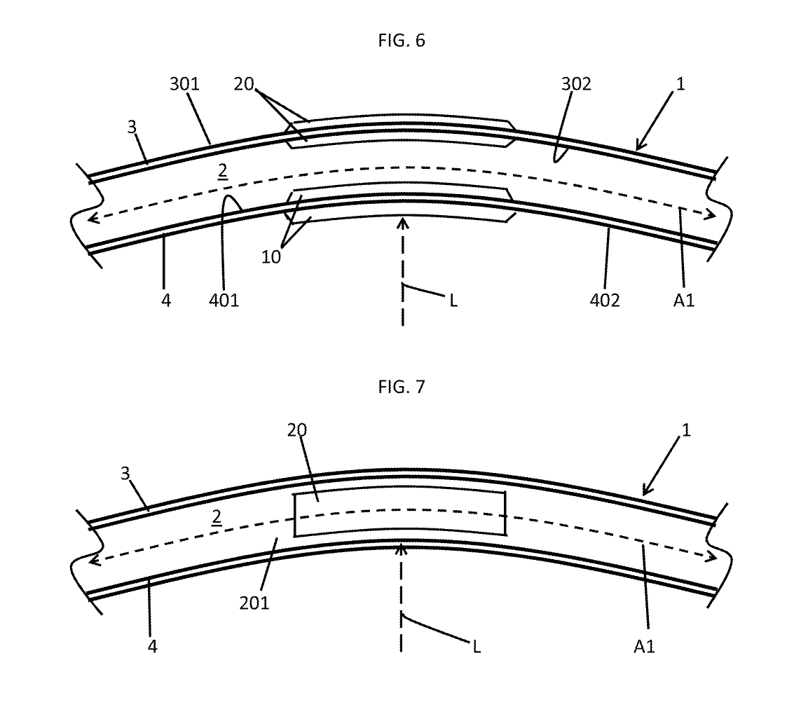

The holes 5 (or other structural discontinuities) provide for various functionalities. However, when the frame structure 1 is subject to loading in at least one principal direction (see, e.g., the application of load L in FIGS. 6 and 7), the holes 5 or the other structural discontinuities can lead to the formation of a stress concentration area 6 in and around the axial location. Within this stress concentration area 6, stress is generated in at least one principal stress direction that corresponds to the principal direction of the loading. Stress may also be generated in at least one secondary stress direction, which is defined transversely or perpendicularly with respect to the principal stress direction.

Although the frame structure 1 is described herein as an I-beam, it is to be understood that this is not required and that the following description is applicable to any type of beam or elongate member. The description of the I-beam embodiment is therefore provided solely as an example for the purposes of clarity and brevity.

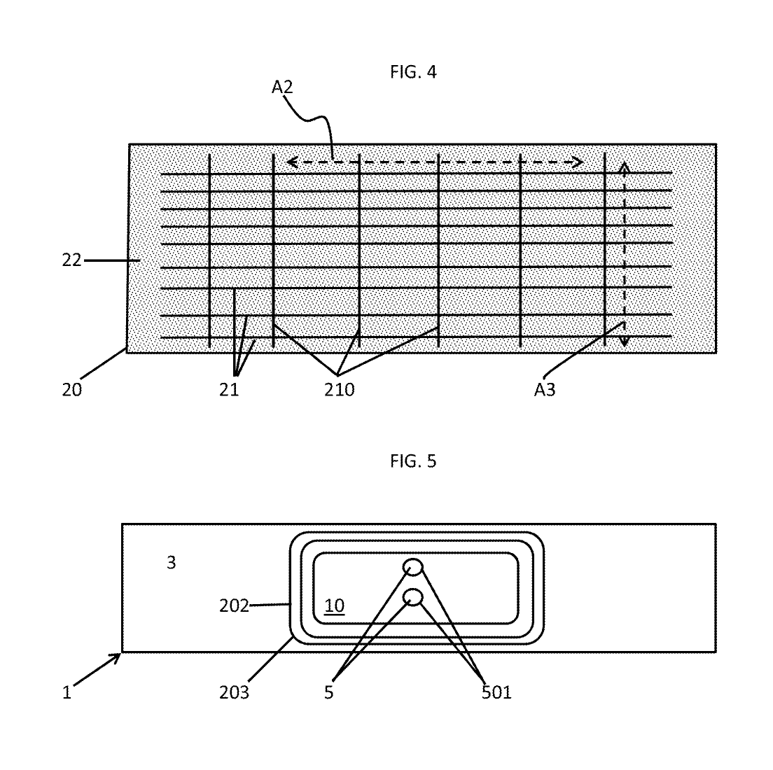

With continued reference to FIGS. 1-3 and with additional reference to FIG. 4, a structural reinforcement member 10 is affixed to the frame structure 1 in order to reinforce the frame structure 1 in and around the holes 5 or the other structural discontinuities and the stress concentration area 6 to therefore mitigate fatigue issues for the frame element 1 and to possibly avoid damage resulting from the formation of the holes 5 or the other structural discontinuities and/or other potential causes of fatigue. The structural reinforcement member 10 includes a polymer matrix composite (PMC) patch element 20 and a bondline 30 that may be in-situ cured on the frame structure 1.

As shown in FIG. 4, the PMC patch element 20 includes principal fibers 21 and secondary fibers 210 suspended within a polymer matrix 22. The principal fibers 21 may be aligned with one another along a common principal longitudinal axis A2 and the secondary fibers 210 may be aligned with one another along a common secondary longitudinal axis A3 defined transversely relative to common longitudinal axis A2. The principal fibers 21 and the secondary fibers 210 may be made of carbon, glass or another other suitable materials. The polymer matrix 22 can be formed of various types of epoxies and resins. In accordance with alternative embodiments, the principal fibers 21 and the secondary fibers 210 of the PMC patch element 20 may include or be formed of carbon, glass, aramid or any other suitable fabric materials. In accordance with still further alternative embodiments, the polymer matrix 22 of the PMC patch element 20 may include or be formed of thermoplastic materials, such as Polyether ether ketone (PEEK) and Polyethersulfone (PES) or any other suitable materials. In general, the choice of materials for the various components of the PMC patch element 20 (i.e., the principal fibers 21, the secondary fibers 210 and the polymer matrix 22) may be made based on particular applications and design constraints.

With reference to FIGS. 1, 2, 3 and 5, the PMC patch element 20 may have a rectangular shape 201 (see FIG. 3) or a rectangular shape 202 with rounded corners 203 (see FIG. 5) and may be tapered (see FIGS. 1 and 2). For the embodiments of FIGS. 3 and 5, the PMC patch element 20 may have a width that is similar to but slightly less than a width of the frame structure 1 and a length that is at least as long as a length of the stress concentration area 6. The tapering 204, as shown in FIGS. 1 and 2, can be provided in a thickness dimension T of the PMC patch element 20 along the edges and corners of the PMC patch element 20. This tapering 204 serves to gradually transfer load in the PMC patched area and therefore minimize high shear and peel at the end of the bondline 30.

The bondline 30 is disposed to affix a major surface of the PMC patch element 20 to a complementary surface of the frame structure 1 at the stress concentration section 6. In so doing, the bondline 30 may be provided such that the principal fibers 21 of the PMC patch element 20 are aligned to extend substantially along or in parallel with the principal stress direction of the loading. Similarly, the secondary fibers 210 may be aligned to extend substantially along or in parallel with the secondary stress direction of the loading.

In accordance with embodiments, the bondline 30 may include at least one of a flexible prepreg 31 or thermoplastic tape 32 as well as adhesive 33 that is co-curable with the PMC patch element 20. In accordance with alternative embodiments, the PMC patch element 20 may be provided initially as a dry fabric that is placed onto the frame structure 1 and then is infused with resin that is subsequently cured and bonded to the frame structure 1. In any case, the PMC patch element 20 is relatively flexible in its uncured state when it is initially applied to or placed on the frame structure 1 such that the principal fibers 21 and the secondary fibers 210 are substantially aligned as described above. Then, once the PMC patch element 20 is cured and thus adhered to the frame structure, the PMC patch element 20 is positioned to resist the bending or deformation cause by the application of the load L.

The PMC patch element 20 can be used to reinforce a metallic structure and share in load transfer to thus reduce stress in the metallic structure. Since stress in metallic structures can lead to fatigue, this reduction in stress provided by the PMC patch element 20 can mitigates issues with such fatigue.

In accordance with embodiments and, with reference to FIGS. 6 and 7, the direction of the application of the load L may be transversely oriented relative to the longitudinal axis A1 of the frame structure 1 such that the frame structure 1 would tend to bend in the plane of the central web 2. In such cases, the bondline 30 may be formed between the PMC patch element 20 and an exterior surface 301/401 of either the first flange 3 or the second flange 4 whereby the PMC patch element 20 and, in particular, the principal fibers 21 are placed in tension to resist the bending tendency of the frame structure 1 due to the loading. Additionally or alternatively, the bondline 30 may be formed between the PMC patch element 20 and an interior surface 302/402 of either the first flange 3 or the second flange 4 whereby the PMC patch element 20 and, in particular, the principal fibers 21 are placed in compression to resist the bending tendency of the frame structure 1 due to the loading. Additionally or alternatively, the bondline 30 may be formed between the PMC patch element 20 and a major surface 201 of the central web 2 whereby the PMC patch element 20 and, in particular, the principal fibers 21 are placed in shear to resist the bending tendency of the frame structure 1 due to the loading.

In accordance with further embodiments, the application of the load L, as described above, may also generate a twisting-type of deformation in the frame structure 1. In such cases, the secondary fibers 210 may be placed in tension or compression to resist such twisting.

In accordance with further embodiments, patch element holes 501 may be cut, drilled or otherwise formed into the PMC patch element 20. Such patch element holes 501 may be disposed to correspond in size, shape and location to the underlying holes 5 of the frame structure 1. The patch element holes 501 may be formed in such a way as to avoid negatively impacting the overall performance of the PMC patch element 20 as a whole. For example, at least one of the principal fibers 21 and the secondary fibers 210 may be disposed to extend around locations of the patch element holes 501 such that the formation of the patch element holes 501 does not cause or require a breakage or discontinuities of the at least one of the principal fibers 21 and the secondary fibers 210.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

1. A structural reinforcement member affixable to a metallic member,
the metallic member defining a stress concentration section at which the metallic member is subject to loading in at least one direction such that stress is generated at the stress concentration section in at least one corresponding principal stress direction,
the structural reinforcement member comprising:
a polymer matrix composite (PMC) patch element comprising fibers suspended within a polymer matrix; and
a bondline disposed to affix the PMC patch element to a surface of the metallic member at the stress concentration section such that the fibers extend along the principal stress direction.

2. The structural reinforcement member according to claim 1, wherein the metallic member is formed to define holes and the PMC patch element reinforces the metallic member against stress concentrations associated with the holes.

3. The structural reinforcement member according to claim 1, wherein the PMC patch has a rectangular shape with rounded corners.

4. The structural reinforcement member according to claim 1, wherein the PMC patch is tapered in a thickness dimension.

5. The structural reinforcement member according to claim 1, wherein the bondline comprises at least one of a flexible prepreg or thermoplastic tape.

6. The structural reinforcement member according to claim 1, wherein the bondline comprises adhesive that is co-curable with the PMC patch element.

7. The structural reinforcement member according to claim 1, wherein PMC patch comprises resin infused fabric.

8. The structural reinforcement member according to claim 1, wherein the loading places the PMC patch in at least one or more of tension, compression and shear.

9. The structural reinforcement member according to claim 1, wherein the metallic member is subject to loading in principal and secondary directions such that stress is generated at the stress concentration section in at least one corresponding principal stress direction and at least one corresponding secondary stress direction,
the PMC patch element comprising principal and secondary fibers suspended within the polymer matrix, and
the bondline being disposed to affix the PMC patch element to the surface of the metallic member at the stress concentration section such that the principal fibers extend along the principal stress direction and the secondary fibers extend along the secondary stress direction.

10. The structural reinforcement member according to claim 1, wherein the PMC patch element and the bondline are in-situ cured on the metallic member.

11. A structural reinforcement method for use with a metallic member defining a stress concentration section at which the metallic member is subject to loading in at least one direction such that stress is generated at the stress concentration section in at least one corresponding principal stress direction, the method comprising:
forming a polymer matrix composite (PMC) patch element comprising fibers suspended within a polymer matrix; and
affixing the PMC patch element to a surface of the metallic member at the stress concentration section such that the fibers extend along the principal stress direction with the PMC patch element thereby reinforcing the metallic member against the loading.

12. The method according to claim 11, wherein the forming comprises tapering the PMC patch element in a thickness dimension.

13. The method according to claim 11, wherein the affixing comprises:
aligning principal ones of the fibers to extend along the principal stress direction; and
aligning secondary ones of the fibers to extend along a secondary stress direction defined transversely relative to the principal stress direction.

14. The method according to claim 11, wherein the affixing comprises co-curing the PMC patch element with adhesive.

15. The method according to claim 11, wherein the affixing comprises in-situ curing of the PMC patch and adhesive on the metallic member.
